(19) United States
(12) Patent Application Publication
(10) Pub. No.: US 2007/0274282 A1
(43) Pub. Date: Nov. 29, 2007

(54) Method for Managing a Group of Network Access Servers

(76) Inventors: Ferenc Deak, Budapest (HU); Wolfgang Entler, Wien (AT); Csaba Garamvolgyi, Budapest (HU); Andrea Matessi, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/572,897

(22) PCT Filed: Jul. 21, 2004
(86) PCT No.: PCT/EP04/08157

§ 371 Date: Apr. 27, 2007

(30) Foreign Application Priority Data
Sep. 22, 2003 (DE) 10343796.7

(51) Int. Cl. H04L 29/06

(52) U.S. Cl. 370/351

(57) ABSTRACT

Disclosed is a method for managing a group of network access servers (ZSI, ZS2, . . . ZSN) wherein the Multichassis Multilink Point to Point Protocol (MMP) is used. An address list of the other network servers of a group (ZS1, ZS2, ZSN) is managed for each network access server of said group (ZS1, ZS2, . . . , ZSN). According to the invention, the logging on and/or off of a new network access server (ZSN+1) to or from said group occurs in such a way that an address list of a network access server (ZS) always includes the current state of the network servers (ZS1, ZS2, . . . , ZSN) in the group. The invention also relates to a network access server (ZS) used to carry out the inventive method.

### CROSS REFERENCE TO RELATED APPLICATION

This application is the US National Stage of International Application No. PCT/EP2004/008157, filed Jul. 21, 2004 and claims the benefit thereof The International Application claims the benefits of German Patent application No. 10343796.7 DE filed Sep. 22, 2003, both of the applications are incorporated by reference herein in their entirety.

### FIELD OF THE INVENTION

The invention relates to a method for managing a group of network access servers, within which group the “Multichassis Multilink Point-to-Point Protocol” (MMP) is used, wherein an address list of the other network access servers in this group is managed by each network access server in this group. The invention also relates to a network access server for carrying out the method according to the invention.

### BACKGROUND OF THE INVENTION

According to the prior art, individual connections in a packet data network using the Point-to-Point Protocol (PPP) can be bundled into a virtual connection having increased bandwidth, wherein this virtual connection is called a Multilink PPP connection (MP) or MP bundle. The PPP has already been standardized in Network Working Group, Request for Comments: 1661, Category: Standards Track “The Point-to-Point Protocol (PPP)”, and the MP in Network Working Group, Request for Comments: 1990, Category: Standards Track “The PPP Multilink Protocol (MP)”.

A typical application for this is e.g. the combination of two B-channels of a basic-rate ISDN connection interface. The PPP packets belonging to the bundled connection can then be transmitted in parallel on both B-channels. Moreover, larger packets can be broken down and the resulting fragments distributed on the B-channels. In this case, a receiving MP entity must be able to reassemble the received fragments and forward the packets in the correct sequence.

Since Remote Access Service (RAS) systems typically consist of a plurality of separate access modules, which are also called Network Access Servers (NAS), a problem arises in the context of Multilink PPP. Specifically, the individual PPP connections belonging to an MP bundle are not generally routed to the same network access server. The information indicating whether an individual PPP connection belongs to an MP bundle, and if so to which, is only available after completion of the PPP negotiations (the LCP phase) and the authentication phase.

It is therefore necessary for the individual network access servers to notify each other concerning the MP bundles they are managing, this being known as “bundle discovery”. Solutions already exist for this purpose, e.g. Network Working Group RFC 2701, Category: Informational Nortel Networks, “Multi-link Multi-node PPP Bundle Discovery Protocol” or Cisco, “Multichassis Multi-link PPP (MMP)”, http://www.cisco.com/warp/public/131/3.html.

As part of the bundle discovery phase, one of the network access servers owning individual PPP connections for a specific MP bundle is selected in order to assume the function of the so-called “bundle head”. All other network access servers forward the multilink packets, which they receive on their PPP connections belonging to the MP bundle, to the bundle head. At the bundle head, the MP fragments are assembled and forwarded in the correct sequence to the higher layers, e.g. to the Internet protocol.

The transport of the multilink packets between the network access servers takes place by means of a Layer-2 tunneling protocol such as L2TP or L2F, for example. The described method is also called Multichassis Multilink PPP (MMP).

The group of network access servers within which MMP is required is also called a “stack group”. The exact procedure and the efficiency of the bundle discovery phase depend inter alia on whether the individual members know each other. This is not the case in the above-cited solution which is described in RFC 2701. If it is detected on a network access server that Multilink PPP was negotiated on a local PPP connection, it is necessary to determine which of the following alternatives applies:
1. The MP bundle already exists and the local network access server itself is bundle head.
2. The MP bundle already exists and a different network access server is bundle head.
3. The MP bundle does not yet exist.

Whether case 1 applies can be detected locally on a network access server. In order to distinguish between case 2 and 3, however, it is necessary to perform a bundle discovery. The following procedure is described in RFC 2701 for this purpose: The network access server sends a request to a distribution list address in the form of an IP Multicast. Since a network access server does not know which other members are included in the group, it is necessary to wait for a specific period in order to see whether a positive reply (in which case a bundle is present) arrives from another network access server (the bundle head). Depending on the network topology concerned, the length of this period must be variously specified and can extend the time which is required to establish a connection.

If a network access server knows the other members of a group, however, it is only necessary to wait until answers, both positive and negative, are received from all members. This is solved thus in the so-called Stack Group Bidding Protocol, (SGBP) (see also Cisco, “Multichassis Multilink PPP (MMP)”, http://www.cisco.com/warp/public/131/3.html), albeit with the disadvantage that the group must be manually configured.

### SUMMARY OF THE INVENTION

The invention therefore addresses the problem of specifying an improved method for managing a group of network access servers.

According to the invention, this is achieved by means of a method of the type cited at the beginning, wherein:
when a new network access server logs onto a group of network access servers, a first message is sent from the new network access server to the network access servers of this group,
the network access servers of this group store the address of the new network access server in an address list and send a second message to the new network access server in each case,
the second messages are received and used by the new network access server for creating and storing an address list of all network access servers in this group.

This is a particularly easy-to-implement and therefore advantageous method for managing a group of network access servers, by means of which an address list of a network access server always has the latest status of the network access servers within the group of the method according to the invention. In this case, a first message of the new network access server is followed by second messages of the network access servers of a group. Since the messages contain the addresses of the senders, it is advantageously possible to establish address lists in the network access servers, both in the new network access server and in the network access servers of the group.

It is also advantageous if
a repetition time is assigned to a network access server in the group, said repetition time specifying the time intervals at which a second message is sent from the network access server in a periodically recurring manner to the other network access servers in the group, and
the network access server is deleted from the address lists of the other network access servers in this group if the second message is not received by them before the expiry of the repetition time.

As part of this activity, a check advantageously determines whether a network access server is actually still a member of the group of network access servers, or whether a connection to this server has failed due to a technical problem, for example. If this is the case, the relevant network access server is deleted from the address lists of the other network access servers.

It is beneficial to provide a method in which
the repetition time is contained in the first message, and
this repetition time is stored in a list by the network access servers of this group when a new network access server logs on.

In this variant, the repetition time is therefore directly transferred from the new network access server to the group of network access servers when it logs on. The network access servers save the repetition time in succession in a list, and can advantageously begin to monitor the arrival of a second message immediately. In this case, it is conceivable to use a separate list or a dedicated column in the address list.

It is also beneficial if, instead of the second message, a fourth message is provided for the periodically recurring notification. In this case, a second message is still used for the logon procedure, but a fourth message which is independent of the logon procedure is used in order to check whether a network access server is actually still a member of the group of network access servers or whether e.g. a connection to this server has failed due to a technical problem. This is advantageous in order to separate the individual method sections more effectively in relation also to the messages.

An advantageous variant of the invention also includes a method
in which a third message is sent by one network access server in the group to the other network access servers in the group and
in which the other network access servers in this group delete this network access server from their address lists when they receive this message.

In this way, a network access server can be logged off from the group actively, i.e. not merely as a result of the absence of a second message. This advantageously avoids possible misunderstandings as to whether the absence of a second message is due to an error or is intentional for the purpose of logging a network access server off.

It is advantageous if a distribution list address is used for sending the first and/or second and/or third messages and the fourth messages within the group of network access servers, said distribution list address including addresses of at least all network access servers in this group, wherein a message contains an identification of the group.

The distribution list address therefore includes at least all potential members of a group. It is also conceivable for different groups to use the same distribution list address, and therefore the recipients of a message analyze a group identification which is transferred at the same time. In this case, it is advantageous for the operator of the packet data network that only limited resources are required for the configuration of the network.

The problem addressed by the invention is also solved by means of a network access server which includes
means for receiving a first message, which message indicates the logging on of a new network access server to a group of network access servers,
means for storing an address of the new network access server in an address list, wherein the address is contained in the first message,
means for sending a second message to the new network access server, and
means for receiving second messages arid means for generating and storing an address list of all network access servers in a group, wherein the addresses are contained in the second messages.

The network server according to the invention therefore enables the particularly easy-to-implement and therefore advantageous inventive method for managing a group of network access servers. In this case, a network access server comprises means for transferring the local address to the network access servers in a group, and means for establishing address lists of the other network access servers in a group.

It is advantageous to provide a network access server which includes
means for the periodically recurrent sending of a second message to the other network access servers in the group,
means for storing a repetition time which is assigned to a network access server,
means for monitoring whether a second message of a network access server was received before the expiry of the repetition time which was assigned to it, and
means for deleting a network access server from an address list.

In this context, the network access server advantageously includes elements for checking whether a network access server is actually still a member of the group of network access servers or whether e.g. a connection to this server has failed due to a technical problem. Said network access server also includes means for continuously indicating its active participation to the other network access servers.

It is beneficial
if the network access server includes means for storing a repetition time, which repetition time is contained in the first message, in a list.

A network access server according to the invention therefore includes means for directly storing the repetition time in a list when a new network access server logs on, and therefore it is advantageously possible to start to monitor the arrival of a second message immediately. In this case, it is conceivable to use a separate list or a dedicated column in the address list.

It is also beneficial if
the network access server includes means for sending a third message to the other network access servers in the group, and
the network access server includes means for deleting a network access server, from which server a third message has been received, from an address list.

In this case, a network access server advantageously includes means for detecting the active logging off of another network access server and means for indicating its own logging off to other network access servers. In this way, it is possible advantageously to avoid possible misunderstandings as to whether the absence of a second message is due to an error or is intentional for the purpose of logging a network access server off.

A beneficial configuration of a network access server is also established if a distribution list address is provided as a means for sending the first and/or second and/or third and fourth messages, wherein said distribution list address includes addresses of at least all network access servers in this group and contains an identification which has been assigned to the group.

The distribution list address therefore includes at least all potential members of a group. It is also conceivable for different groups to use the same distribution list address, and therefore the recipients of a message have means for analyzing a group identification which is transferred at the same time. In this case, it is advantageous for the operator of the packet data network that only limited resources are required for the configuration of the network.

### BRIEF DESCRIPTION OF THE DRAWINGS

The invention is explained in greater detail with reference to an exemplary embodiment which is illustrated in the figures and relates to the logging on and off of a network access server to and from a group of network access servers, wherein:

FIG. 1: shows the logging on of a new network access server ZSN+1 to a group of network access servers ZS1, ZS2, . . . , ZSN;

FIG. 2: shows an acknowledgement in the form of a second message N2 from the group of network access servers ZS1, ZS2, . . . , ZSN to the new network access server ZSN+1;

FIG. 3: shows the periodically recurring report from a network access server ZS to the other network access servers in the group;

FIG. 4: shows the logging off of the n-th network access server ZSN from the group of network access servers ZS.

### DETAILED DESCRIPTION OF THE INVENTION

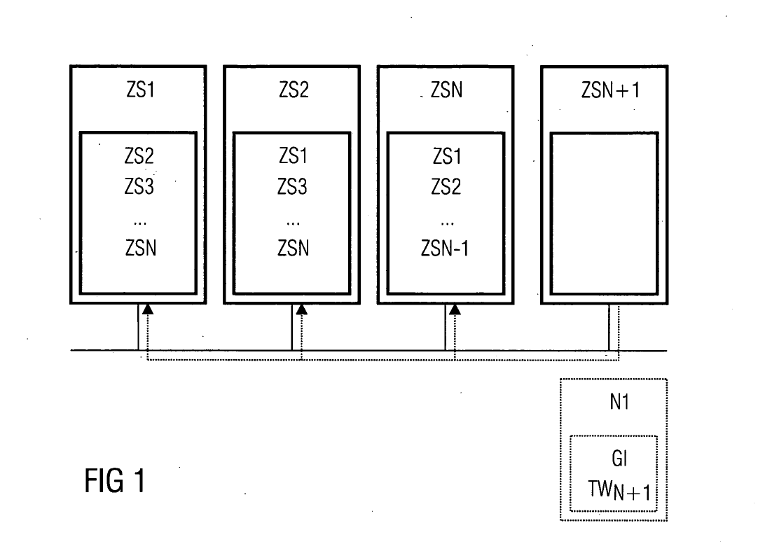

Each of the FIGS. 1 to 4 shows a first to n-th access server ZS1, ZS2, . . . , ZSN and a new access server ZSN+1. In this case, all access servers ZS are connected to each other and can exchange messages over these connections. Furthermore, each access server ZS has a list of the other network access servers ZS in the group.

The function of the arrangement which is illustrated in the figures is explained in greater detail below.

FIG. 1 shows the logging on of a new network access server ZSN+1 to a group of network access servers ZS1, ZS2, . . . , ZSN. Since each access server ZS includes a list of the other network access servers ZS in the group, the address list of the first network access server ZS1 shows e.g. the entries ZS2, ZS3, . . . , ZSN. The address list of the new network access server ZSN+1 is still empty, however. As a first step, a first message N1 is sent from the new network access server ZSN+1 to the group of network access servers ZS1, ZS2, . . . , ZSN. This takes place via a distribution list address which includes the addresses of all network access servers in this group ZS1, ZS2, . . . , ZSN. Since the distribution list address can also include other network access servers ZS, the first message N1 contains an identification of the group GI. In addition, the first message N1 contains a repetition time TWN+1 which has been assigned to the new network access server ZSN+1.

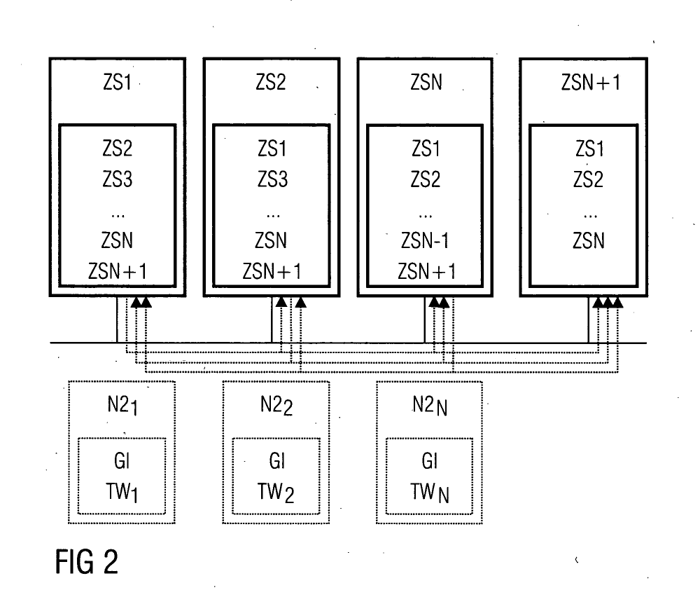

Next—as shown in FIG. 2—the address of the new network access server ZSN+1 is entered in the address lists of the network access servers of the group ZS1, ZS2, . . . , ZSN. Therefore the address list of the first network access server ZS1 now shows the entries ZS2, ZS3, . . . , ZSN, ZSN+1. In this case, it is assumed that the repetition time TWN+1 is stored in a special column, though for greater clarity this is not shown in the figure. The address list of the new network access server ZSN+1 is still empty at this time point, however. Next, second messages N21, N22, . . . , N2N are sent from the network access servers of the group ZS1, ZS2, . . . , ZSN to the distribution list address. However, each of these messages also contains an identification of the group GI and the repetition times TW1, TW2, . . . , TWN that have been assigned to the network access servers. As a next step, an address list is now also constructed in the new network access server ZSN+1. This list includes the entries ZS1, ZS2, . . . , ZSN.

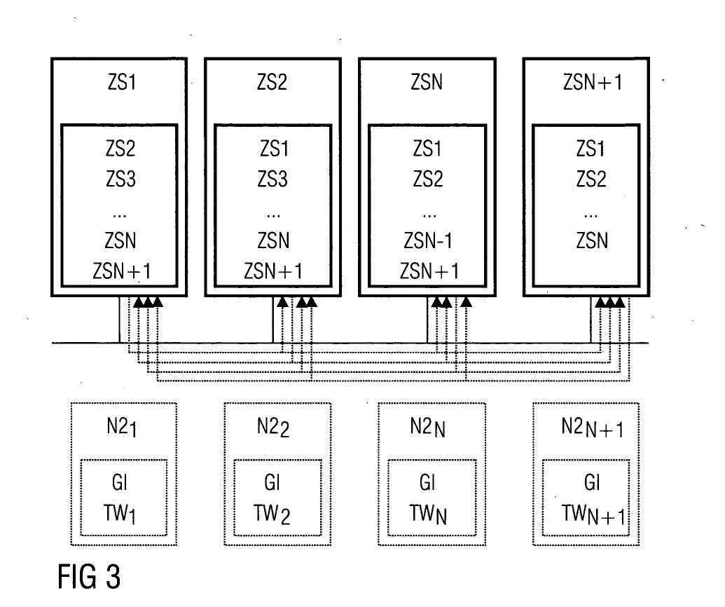

FIG. 3 shows that each network access server ZS in the group ZS1, ZS2, . . . , ZSN+1 sends a second message N21, N22, . . . , N2N+1 to the other network access servers ZS in the group in a periodically recurring manner, specifically at the repetition times TW1, TW2, . . . , TWN+1. In this case, a network access server ZS is deleted from the address lists of the other network access servers ZS in this group if the second message N2 is not received from said network access server before the expiry of the repetition time TW. This condition does not occur in the example shown, however. Therefore the address lists remain unchanged.

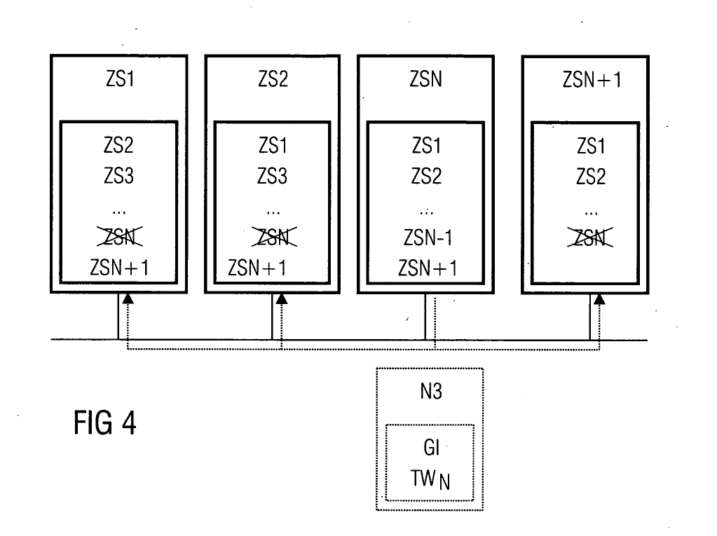

FIG. 4 shows the logging off of the n-th network access server ZSN from the group of network access servers ZS. For this, a third message N3, which again includes the identification of the group GI and an assigned repetition time TWN, is sent via the distribution list address to the other network access servers ZS in the group. Upon receipt of this message N3, the address list there is adapted accordingly, i.e. the n-th access server ZSN is deleted.

1-8. (canceled)

9. A method for managing a group of network access servers within which group the Multichassis Multilink Point-to-Point Protocol is used, comprising:
managing an address list of the other network access servers in this group by each network access server in this group,
wherein when a new network access server logs onto a group of network access servers, a first message is sent from the new network access server to the network access servers of this group, the network access servers of this group store the address of the new network access server in an address list and send a second message to the new network access server in each case, and the second messages are received and used by the new network access server for creating and storing an address list of all network access servers in this group.

10. The method as claimed in claim 9, wherein a repetition time is assigned to a network access server in the group, the repetition time specifying the time intervals at which the second message is sent from the network access server in a periodically recurring manner to the other network access servers in the group, and the network access server is deleted from the address lists of the other network access servers in this group if the second message is not received by them before the expiry of the repetition time.

11. The method as claimed in claim 9, wherein the repetition time is contained in the first message, and this repetition time is stored in a list by the network access servers of this group when a new network access server logs on.

12. The method as claimed in claim 10, wherein instead of the second message a fourth message is provided for the periodically recurring notification.

13. The method as claimed in claim 9, wherein a third message is sent by a network access server in the group to the other network access servers in the group, and the other network access servers in this group delete this network access server from their address lists when they receive this message.

14. The method as claimed in claim 9, wherein a distribution list address is used for sending the first and/or second and/or third messages and a fourth messages within the group of network access servers, the distribution list address including addresses of at least all network access servers in this group and a message contains an identification of the group.

15. A network access server which includes a device for linking into a group of network access servers and the Multichassis Multilink Point-to-Point Protocol is used within the group, comprising:
an address list of the other network access servers in this group;
a device for receiving a first message which indicates the logging on of a new network access server to a group of network access servers;
a device for storing an address of the new network access server in an address list and the address is contained in the first message;
a device for sending a second message to the new network access server; and
a device for receiving second messages and a device for generating and storing an address list of all network access servers in a group, wherein the addresses are contained in the second messages.

16. The network access server as claimed in claim 15, further comprising:
a device for the periodically recurrent sending of the second message to the other network access servers in the group;
a device for storing a repetition time which is assigned to a network access server;
a device for monitoring whether the second message of a network access server was received before the expiry of the repetition time which was assigned to it; and
a device for deleting a network access server from an address list.
